(19) United States
(12) Patent Application Publication
(10) Pub. No.: US 2004/0254902 A1
(43) Pub. Date: Dec. 16, 2004

(54) Second Opinion Selection System

(76) Inventor: David Lawrence Von Klleeck, Valley Cottage, NY (US)

Correspondence Address: JEFFREY FURR, 253 N. MAIN STREET, JOHNSTOWN, OH, 43031, US

(21) Appl. No.: 10/710,008

(22) Filed: Jun. 11, 2004

Related U.S. Application Data
(60) Provisional application No. 60/320,261, filed on Jun. 11, 2003.

(51) Int. Cl. G06F 17/60; G06G 7/00; G06F 15/18; G06N 3/00; G06N 3/12; G06E 1/00; G06E 3/00

(52) U.S. Cl. 706/16; 706/13; 706/8; 705/1

(57) ABSTRACT

This invention, relates to a generic system and method for supporting hiring decisions based on biographical information blank input, more particularly, this system and method yields superior decisions through the use of soft computing technologies (fuzzy logic, neural networks, and genetic algorithms) to better score biographical information blanks.

### CROSS REFERENCE TO RELATED APPLICATIONS

This is a Non-Provisional of Provisional Patent Application No. 60/320,261 filed on Jun. 11, 2003.

### BACKGROUND OF INVENTION

This invention, relates to a generic system and method for supporting hiring decisions based on biographical information blank input, more particularly, this system and method yields superior decisions through the use of soft computing technologies (fuzzy logic, neural networks, and genetic algorithms) to better score biographical information blanks.

1. Background

The hiring of insurance agents involves an agent selection process. This is usually a multi-step personnel selection process. In such a generic model, the initial the initial steps begin the process with an application and an interview.

During the middle steps, various instruments are administered to develop “selection scores”. These scores are then integrated with information from earlier steps to provide input to selection process”s initial decision node. Taken together, this information is critical to a company”s decision support system for recruiting and hiring.

The results from the above decision process results in either one of two “system states” depending on the sophistication of the selection process. In the more rudimentary system, the decision is merely a “hire” or “no hire”, “offer extended” or “case closed”. In the more complex selection system, three situations typically result. These are:1. “Code Red”—terminate the selection process2. “Code Yellow”—proceed with caution3. “Code Green”—continue the selection process.

Thus outcome is either to proceed based on the information gathered up to the first decision point or, to classify candidates into three categories, red, green, and yellow. Red candidates have low production potential and are dropped from the selection process at this point. Green candidates are viewed as have high production potential and are actively pursued as agents. Yellow are viewed as potentially good candidates.

“Code Yellow” candidates must be more closely scrutinized. Such scrutiny can be done through “testing” or by using other methods to score already existing instruments. Such scrutiny can be done with the use of computer systems.

Since their inception, many computer systems, particularly business systems, have been used primarily to capture, store and report on data associated with individual transactions of some type, such as health care claims, bank deposits, or purchase orders. These systems have been very successful in automating manual procedures, but have created a huge volume of stored data that is not being adequately utilized to make qualitative decisions (e.g. business decisions).

This need has spawned a generation of so-called decision support and expert systems designed to assist the human decision making process. In some cases these systems use a rudimentary method of encoding human knowledge to process data and, in other cases; the informational value of data is increased through the use of various data navigation tools and techniques.

One major difficulty in programming behavior profiling stems from a limiting factor present in most modern digital computer systems, binary logic. Digital computers, and the programming languages used to program them, are based on a logic system that supports only two truth states, represented as 0 (false) and 1 (true). This constraint poses significant challenges in dealing with large combinatorial problems that are more properly represented with a multi-valued logic.

Technologies constrained by discrete comparisons and a two-valued logic system are inadequate for coping with the intractable nature of this kind of problem.

One approach to this problem has been to encode what is known about hiring decisions in If-Then statements, or rules, which can be used to assist in the decision process. There are a wide range of factors that need to be examined simultaneously, and the result must be a composite evaluation of the overall data. The number of If-Then rules needed to test discrete values, or ranges of values, taking dozens or hundreds of constantly changing factors into account is nearly impossible to create, and is surely impossible to maintain.

Mathematical or statistical modeling is an alternative, and popular, method of conducting behavior profiling analysis that has fewer drawbacks but still falls short of a practical solution.

In this case, statistical normality for a peer group is calculated for a small manageable number of behavior characteristics known about a subject. For each physician in the peer group, a rigorous mathematical calculation is used to measure the combined degree to which that physician deviates from normal behavior for all behavior characteristics. This approach involves calculating a summary of standard deviations that identify the statistical outliers within the peer group.

This approach benefits from the objectivity achieved through peer group analysis, as opposed to arbitrary threshold limits set by domain experts, but lacks the flexibility and extensibility required of a meaningful and practical solution.

A purely statistical approach to agent hire decisions profiling has been shown to be computationally impractical when dealing with a large number of frequently changing behavior characteristics. Another drawback to this approach is the tendency of statistical modeling to lose access to the detailed information used to derive its conclusions.

This invention uses another approach to insurance agent hire decision. It is the use of neural network technology to ‘mine’ databases to search for hiring factors. In this case, a neural network would be provided a training set of known insurance agent profiles and it would be trained to recognize the characteristics of a good hire by drawing relationships between the data elements in the training set. Once the training of the neural network is complete, it would then be used to scan the potential agents in search of hires matching the neural networks ‘learned’ understanding of agents.

2. Description of Prior Art

The use of fuzzy rules and neural networks are relatively new. Some of the patents in this area are as follows.

U.S. Pat. No. 6,317,730 by Neuneier, et al. and issued on Nov. 13, 2001 discloses a set of fuzzy rules (FR) mapped onto a neural network (NN). The neural network (NN) is trained, and weights (w.sub.i) and/or neurons (NE) of the neural network (NN) are pruned or grown. A new neural network (NNN) formed in this way is mapped onto a new fuzzy rule set (NFR).

U.S. Pat. No. 5,499,319 by Al Janabi, et al. and issued on Mar. 12, 1996 discloses a design and implementation of a real-time knowledge-based fuzzy controller system for general purpose industrial applications.

U.S. Pat. No. 5,724,488 by Prezioso and issued on Mar. 3, 1998 and U.S. Pat. No. 5,577,169 also by Prezioso and issued on Nov. 19, 1996 disclose a system where the behavior of entities with common characteristics is profiled using fuzzy logic.

U.S. Pat. No. 6,463,431 by Schmitt Oct. 8, 2002 discloses a database evaluation system provides for intuitive end user analysis and exploration of large databases of information through real time fuzzy logic evaluation of utility preferences and nearest neighbor exploration.

U.S. Pat. No. 6,253,186 by Pendleton, Jr. and issued on Jun. 26, 2001 discloses a computerized arrangement for detecting potentially fraudulent suppliers or providers of goods or services and includes a processor, a storage device, an input device for communicating data to the processor and storage device, and an output device for communicating data from the processor and storage device.

U.S. Pat. No. 5,983,220 by Schmitt and issued on Nov. 9, 1999 discloses a database evaluation system providing for intuitive end user analysis and exploration of large databases of information through real time fuzzy logic evaluation of utility preferences and nearest neighbor exploration.

U.S. Pat. No. 5,701,400 by Amado and issued on Dec. 23, 1997 discloses a system for applying artificial intelligence technology to data stored in databases and generating diagnostics that are user definable interpretations of information in the database. This invention uses the old if-the-else logic.

For the foregoing reasons, there is a need for a complex behavior profiling that has a solution that is flexible, extensible, domain independent, and can be routinely implemented in varying types of computing environments with commonly available skills.

### SUMMARY OF INVENTION

This invention is a system and method for supporting hiring decisions based on biographical information blank input, more particularly, this system and method yields superior decisions through the use of soft computing technologies (fuzzy logic, neural networks, and genetic algorithms) to better score biographical information blanks.

Accordingly, it is an object of the present invention to provide an improved system and method that is capable of determining hiring decisions.

The present invention novelly uses fuzzy logic principles to calibrate, measure and combine very subtle data provided by the hire and to determine a hire/no-hire profile.

These, together with other objects of this invention, along with various features of novelty which characterize this invention, are pointed out with particularity in the claims annexed hereto and forming a part of this disclosure. For a better understanding of this invention, its operating advantages and the specific objects attained by its uses, reference should be had to the accompanying drawings and descriptive matter in which there is illustrated a preferred embodiment.

### BRIEF DESCRIPTION OF DRAWINGS

Without restricting the full scope of this invention, the preferred form of this invention is illustrated in the following drawings:

FIG. 1 is a block diagram showing a basic arrangement of a computer system that embodies the present invention.

FIG. 2 is a block diagram showing how the potential agents are grouped using selective scores.

FIG. 3 is a flow chart showing the steps of a preferred embodiment of the present invention.

### DETAILED DESCRIPTION

The present invention novelly uses fuzzy logic principles to calibrate, measure and combine very subtle data provided by the hire and to determine a hire/no-hire profile.

Analysis performed on life insurance industry data has shown that the application of certain Artificial Intelligence (AI) technologies can improve the prediction of agent retention by nearly fifty percent (50%). This can result in an over thirty three percent (33%) reduction in agent development cost. These results can be replicated, perhaps even improved, when tailored to company specific data and hiring processes.

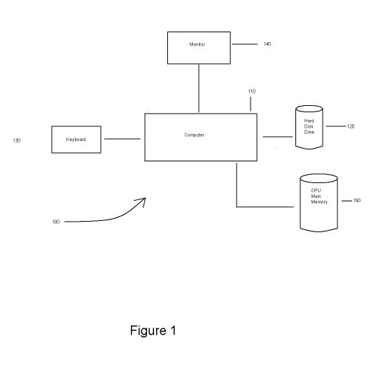

The system 1 is set to run a on a computing device. FIG. 1 is a block diagram showing a computing device 100 on which the present invention can run comprising a CPU 110, Hard Disk Drive 120, Keyboard 130, Monitor 140, CPU Main Memory 150 and a portion of main memory where the fuzzy logic profiler resides and executes. A printer can also be included. Any general purpose computer with an appropriate amount of storage space is suitable for this purpose. Computer Devices like this are well known in the art and is not pertinent to the invention.

The hiring a prospective hire and more particularly the hiring of insurance agents involves an agent selection process. This is usually a multi-step personnel selection process. In such a generic model, the initial the initial steps begin the process with an application and an interview.

During the middle steps, various instruments are administered to develop “selection scores”. These scores are then integrated with information from earlier steps to provide input to selection process”s initial decision node. Taken together, this information is critical to a company”s decision support system for recruiting and hiring.

The results from the above decision process results in either one of two “system states” depending on the sophistication of the selection process. In the more rudimentary system, the decision is merely a “hire” or “no hire”, “offer extended” or “case closed”. In the more complex selection system, three situations typically result. These are:1. “Code Red”—terminate the selection process2. “Code Yellow”—proceed with caution3. “Code Green”—continue the selection process.

Thus outcome is either to proceed based on the information gathered up to the first decision point or, to classify candidates into three categories, red, green, and yellow. Red candidates have low production potential and are dropped from the selection process at this point. Green candidates are viewed as have high production potential and are actively pursued as agents. Yellow are viewed as potentially good candidates.

“Code Yellow” candidates must be more closely scrutinized. Such scrutiny can be done through “testing” or by using other methods to score already existing instruments. Such scrutiny can be done with the use of computer systems.

Candidates whose potential is assessed as “Code Yellow” represent a potentially greater risk for failure than do their “Code Green” counterparts. And yet, most of the candidates in this category are hired anyway, along with the “Code Green” candidates. This selection system simplification leads to a lower retention rate. It is the primary cost driver in the agent development process.

As stated above, “Code Yellow” candidates must be more closely scrutinized. Such scrutiny can be done through “testing” or by using other methods to score already existing instrument data. Further testing is expensive and time consuming, leaving the alternative of applying other scoring techniques as more desirable. If the “Code Yellow” candidates data could be submitted for a second opinion that classify them as either red or green, it would represent a significant potential for risk reduction and cost savings.

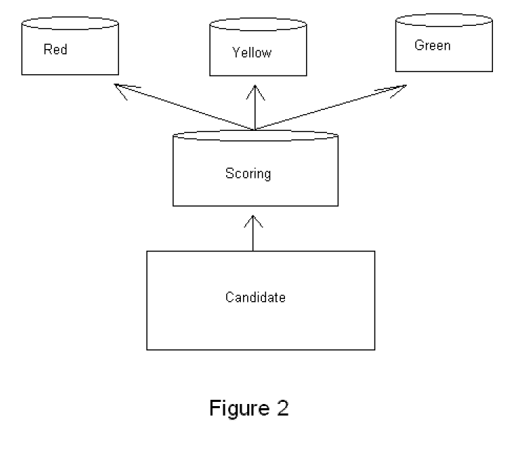

The current invention, which is a second opinion selection system 1 (SOSS) is a system that would generate a second opinion of the candidates to classify them as red or green, see FIG. 2. It is based on a different and more advanced set of scoring algorithms. These algorithms incorporate a field of artificial intelligence known as machine learning to more closely tailor the scoring process. Thus the calibrated SOSS would be based on a company's “way of developing agents and doing business”. It would incorporate “Company”s Intelligence” into the automated portion of their prospective agent selection process.

In the preferred embodiment, the SOSS 1 is a done in three layers: 1. Preparation of data, 2. Inter Data Reduction Layer and 3. Fuzzy-inference layer.

Some of these processes are disclosed in the following texts which are incorporated by reference, Artificial Intelligence by M. Negnevitsky, Fundamental of Neural Networks by L. Fausett, Genetic Algorithms by D. E. Goldberg and Machine Learning by T. M. Mitchell. The present invention uses some of the principles of fuzzy logic as published by L. A. Zadeh and discussed in U.S. Pat. No. 5,167,005 to Yamakawa filed on Aug. 11, 1989, U.S. Pat. No. 5,179,625 to Hisano filed on May 5, 1992, U.S. Pat. No. 5,724,488 by Prezioso and U.S. Pat. No. 5,577,169 also by Prezioso which are herein incorporated by reference in their entirety.

The system's 1 input is biographical data blanks that consist of a series of forced-choice, single-answer, multiple choice questions called “items”. This simply means that some one is required to pick an answer from a list of potential answers that best “fits” their situation.

For example: Level of education—A. Grade School B. High School C. Associates D. Bachelors E. Higher College.

If the response is E, then this is then encoded into a binary set of 00001=E. (01000=B etc). Each item is encoded in the same manner and those results a used to form a direct access file for processing by the second and thrid levels of the system 1.

The system”s 1 input can also be based on personality type questions such as those used for the Myers Briggs. As above, these questions are encoded into a binary set with each item being encoded and the results used to form a direct access file for processing b the second and third levels of the system 1.

SOSS is an example of a two step process:The Two Step Process:1.Use traditional OR technologies to identify key, high-payoff decision nodes with in an organization.

2.Use the advanced information technologies of AI to develop intelligent decision support tools to “mine” the payoff.

In Step 1, identify the agent selection decision node in the life insurance industry as a high-payoff node. Studies show that the cost of developing a successful agent”s cost is $300,000.00. This process typically involves a rigorous four year program that often retains less than twenty percent of its original starting cohort. Much of this cost is attributable to the low retention rate. Such results clearly reflect poorly on the quality of management decisions in the selection process. If in fact, if the retention rate were boosted to thirty percent, the associated costs could be reduced by about one third. Companies in the insurance industry typically rely on personnel selection instruments to screen candidates. Such instruments are helpful, but often require companies to set a threshold at a low level in order to get a higher desired “capture” rate. In turn, this counters the goal of maintaining a cost effective retention rate.

In Step 2, the Inventors developed an intelligent decision support system that allows Life Insurance companies to set a high threshold for its “code green” candidates while getting a “second opinion” on the “code yellow” candidates. The resulting benefits of this system are:

Maintaining a high retention rate (30%).

Achieving a higher capture rate (90%).

Reducing costs per retained agent by $100,000.00 (33%).

Significantly increasing profitability (20%).

The method is a Second Opinion Selection System (“SOSS”) which was developed using a classical Systems Identification (SI) process and is typically used to engineer a “bridge” between system inputs and system outputs when the “real” system is not known. It consists of two steps: 1. Model identification and 2. Model parameter estimation.

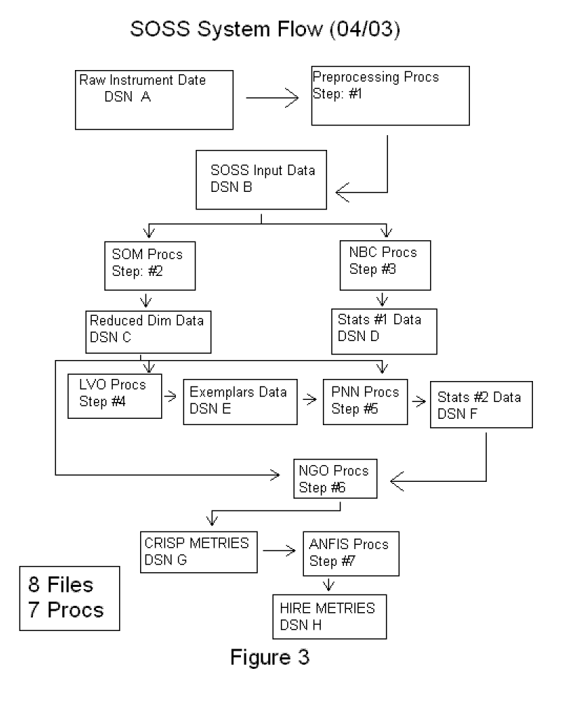

Since Artificial Neural Networks (ANNs) and Fuzzy Inference Systems (FISs) are known to be universal approximators, they are used for step 1, while Machine Learning (ML) is used for step 2. as shown in FIG. 3.

Model 1 identified for SOSS consists of 5 ANNs and 1 FIS, and the model parameters were estimated using 5 MLs. SOSS is a highly developed hybrid AIT. The 5 ANN s are identified in the SOSS system flow as steps 2-7, while the FIS is step 7 (Adaptive Neuo-Fuzzy Inference System—ANFIS).

The 5 ANNs are: 1. Self Organizing Map (SOM) step 2, 2. Naive Bayesian Classifier (NBC) step 3, 3. Learning Vector Quantization (LVQ) step 4, 4. Probabilistic Neural Network (PNN) step 5 and 5. Neural Genetic Optimizer (NGO) step 6.

The 5 MLs are: 1. Kohonen Learning used in the SOM & LVQ, 2. Bayesian Learning used in the NBC, 3. Widrow-Huff Learning used in the PNN, 4. Back propagation Learning used in the NGO, and 5. Generic Algorithms (Gas) used in NGO & ANFIS and overall SOSS process.

The process has an input factor of 200 versus an output factor of 10. SOM and NBC output is designed to be linear scaling with a potential output between −1 and +1.

Advantages

The previously described version of the present invention has many advantages, including it yields a better retention rate, it requires neither new data nor new instrument, and it uses leading edge technologies to score the same selection instrument, producing clearly superior results.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed. Therefore, the point and scope of the appended claims should not be limited to the description of the preferred versions contained herein.

I claim:

1. A system for hiring an employee comprising:
a) inputing data,
a) having a Model identification step review said data and output results;
b) having a Model parameter estimation step review said output results; and
d) outputting final results.

2. A system according to claim 1 where said model identification step comprises identifying by decision nodes.

3. A system according to claim 1 where said model identification step uses artificial neural networks to review said data.

4. A system according to claim 1 where said model identification step uses fuzzy inference systems to review said data.

5. A system according to claim 1 where said model parameter estimation step uses machine learning to review said output results.

6. A system according to claim 4 where said fuzzy inference systems uses one or more of the following set of artificial neural networks to review said data; Self Organizing Map, Naive Bayesian Classifier, Learning Vector Quantization, Probabilistic Neural Network and Neural Genetic Optimizer.

7. A system according to claim 4 where said fuzzy inference systems to review said data first uses Self Organizing Map, then uses Naive Bayesian Classifier, then uses Learning Vector Quantization, then uses Probabilistic Neural Network and then uses Neural Genetic Optimizer.

8. A system according to claim 1 where said model parameter estimation step uses one or more of the following set of artificial neural networks to review said output results Kohonen Learning, Bayesian Learning, Widrow-Huff Learning, Back propagation Learning and Generic Algorithms.

9. A system according to claim 1 where said results have two states.

10. A system according to claim 9 where said states are hire and do not hire.

11. A system according to claim 1 where said results have three states.

12. A system according to claim 11 where said states are no not move forward, move forward with caution and move forward.

13. A system according to claim 1 where said data is biographical data.

14. A system according to claim 1 where said data is personality data.

15. A system according to claim 11 where the system re-reviews the results from the processing and reviews the results from the middle state and places it in one of the other two states.

16. A system for offering a second opinion to re-score data:
a) inputing data,
a) having a Model identification step review said data and output results;
b) having a Model parameter estimation step review said output results; and
d) outputting final results.

17. A system according to claim 16 where said model identification step comprises identifying by decision nodes.

18. A system according to claim 16 where said model identification step uses artificial neural networks to review said data.

19. A system according to claim 16 where said model identification step uses fuzzy inference systems to review said data.

20. A system according to claim 18 where said fuzzy inference systems uses one or more of the following set of artificial neural networks to review said data; Self Organizing Map, Naive Bayesian Classifier, Learning Vector Quantization, Probabilistic Neural Network and Neural Genetic Optimizer.
